(19) United States
(12) Patent Application Publication
(10) Pub. No.: US 2008/0273601 A1
(43) Pub. Date: Nov. 6, 2008

(54) Communication Network Based on Master/Slave Architecture for Connecting Sensors and Actuators

(75) Inventor: Christopher James Cowdery, Huntingdon (GB)

Correspondence Address: FOLEY AND LARDNER LLP;SUITE 500, 3000 K STREET NW, WASHINGTON, DC, 20007, US

(73) Assignee: NEW TRANSDUCERS LIMITED, Huntingdon (GB)

(21) Appl. No.: 11/597,367

(22) PCT Filed: May 17, 2005
(86) PCT No.: PCT/GB05/01903

§ 371 Date: May 21, 2007

(30) Foreign Application Priority Data
May 28, 2004 (GB) 0411991.3

(51) Int. Cl. H04B 3/00

(52) U.S. Cl. 375/257

(57) ABSTRACT

A communications network for servo systems and the like comprises a controller, first and second slave nodes configured to respond to control signals from the controller and to send respective feedback control signals to the controller, and a control signal transmission line between the controller and the slave nodes; wherein communication between said controller and said slave nodes employs reflective signaling, and wherein the transmission line incorporates a router configured to route control signals from said controller to one or other of said first and second slave nodes in dependence on a further signal from said controller.

### TECHNICAL FIELD

The present invention relates to communication networks, particularly but not exclusively for servo systems.

### BACKGROUND ART

Fly by wire is a term used to describe the use of an electrical connection to replace a mechanical connection in a servo system connecting an operator and some kind of machinery. It is used in its broadest sense here to cover technologies such as drive by wire, steer by wire, brake by wire, throttle by wire etc.

The most obvious example of fly by wire is on a modern plane where the pilot controls are processed by computer before being passed to the flight control surfaces. The technology has been used in the aeronautical area for approximately 35 years (starting with Concorde), although the implementations used are exceedingly expensive.

A major growth area for fly by wire technology at the present is in the automotive space. Vehicle manufacturers are enhancing driver experience and vehicle safety by removing the direct link between driver and vehicle, and processing driver input before controlling the vehicle.

A current example is throttle by wire, which is used on all modern diesel engines and which gives the engine control unit (ECU) complete control over engine behaviour. Another example is electronic brake assist whereby the braking system will bring the vehicle to a stop as quickly as possible even if the driver is not pressing the brake pedal hard enough to do so. Thus driver intention is being used rather than driver action.

A design goal for future vehicles (as exemplified by the EU sponsored X-by-wire project) is steer by wire. Unlike present systems comprising a mechanical variable steering ratio under overall electronic control, a full steer by wire implementation will have no mechanical linkage between steering wheel and road wheels. Benefits will include more cabin design freedom and the ability to compensate handling characteristics for load, cross wind, road speed, etc. It will be appreciated that such a steer by wire system must be fault tolerant.

It is apparent from the examples above that such systems are safety critical. It must not be possible to cause personal injury from a failure of the system.

It is also apparent from the nature of the applications that use fly by wire technology that the underlying technology must support real time operation. For example, the response of a steer by wire system must be indistinguishable from ‘instant’ by the driver. From a technical point of view, the term real time is used to describe a system that must guarantee a response to an external event within a given time, i.e. it is deterministic. If a system is completely deterministic, it is termed ‘composable’ and can have statistical models applied to evaluate the performance under various operating conditions. This is an essential feature as it enables analyses to be performed to prove reliability and fault condition behaviour.

As mentioned above, many fly by wire applications are based around a single controller that instructs multiple servo systems, e.g. for various flight control surfaces. Whilst it is possible to provide a direct, hard-wired link between the controller and each of the multiple servo systems, such an approach is not appropriate in systems having a large number of servos (as in modern aircraft and automotive applications) since it results in unacceptable weight and cost. Instead, it is preferred to use a common bus operating according to one of two main approaches, namely “event-triggered” and “time-triggered.”

An event-triggered architecture is an architecture where the various nodes on the architecture will become active as soon as their triggering event occurs. This immediately presents a problem where multiple nodes share a bus since simultaneous or near simultaneous external events will cause bus contention. The usual strategy for dealing with this is for every node to back off for a random time period, then retry. Eventually one node will take control of the bus before any others, complete its communication, and release bus ownership. At this point, other waiting nodes will attempt to gain control of the bus, possibly causing another round of contention. Ethernet is an example of an event-triggered system.

The major shortcoming of such an event-triggered system is that it is not possible to predict in advance if or when a node will be able to acquire bus ownership. Moreover, this uncertainty will increase as bus traffic increases. Consequently an event-triggered system cannot be used in a real time environment. Furthermore, an event-triggered system is not composable, and cannot therefore be analysed to prove its error performance characteristics. This is unacceptable for a safety critical system.

An alternative approach is a time-triggered architecture in which each node on the bus has a specific time slot of a given length repeating on a regular basis. During that time slot, that particular node owns the bus and can transmit and receive data. Outside the time slot, the node must remain silent. An external event will be queued inside the associated node until the next available timeslot for that node occurs and at that point the pending communications will take place.

This architecture overcomes the shortcomings of the event-triggered architecture, insofar as the bus contention issue should never arise. In addition, the global timebase allocation ensures that the overall system is composable since a maximum delay between an external event and the next available timeslot can be determined in advance. However a preallocation of time slots operating over a shared medium has certain ramifications. Firstly, a ‘babbling idiot’ that transmits outside its timeslot can potentially bring the entire system down. ‘Bus guardians’ can be used to prevent babbling idiots but add complexity and can fail themselves. Secondly, the whole network must run on a common synchronised timebase which must somehow be communicated to and stored in every network node. Some kind of start/restart algorithm must be provided to synchronise the clocks and timeslots. Thirdly, the bandwidth allocation is static. If it is to be changed, then each part of the network must be informed and acknowledge the change.

Accordingly, even though the time-triggered architecture offers advantages over an event-triggered architecture, it still falls short of an ideal solution. The present invention seeks to ameliorate at least some of the deficiencies of the known systems.

### DISCLOSURE OF INVENTION

Accordingly, the present invention consists in a communications network for servo systems and the like comprising: a controller; first and second slave nodes configured to respond to control signals from the controller and to send respective feedback control signals to the controller; and a control signal transmission line between the controller and the slave nodes; wherein communication between said controller and said slave nodes employs reflective signalling, and wherein the transmission line incorporates a router configured to route control signals from said controller to one or other of said first and second slave nodes in dependence on a further signal from said controller.

Such an arrangement avoids the contention problems of the event-triggered system. As a result of the router, all bus communication is under direct control of a single node on the bus, namely the controller or master node.

Furthermore, unlike the time-triggered system, there is no need to wait for a particular time slot before communication takes place. Accordingly, real time performance is achievable and there is no requirement for a global timebase to be distributed across all nodes within the network. In particular, the use of reflective signalling allows the first and second slave nodes to feedback substantially instantly to the controller.

Reflective Signalling principles are described in detail in WO/99/35780 (incorporated herein by reference). At its most basic level, the method involves the steps of (a) transmitting a signal from a first equipment to a second equipment; (b) reflecting said signal back to said first equipment in a manner corresponding to a first bit sequence; (c) receiving the signal thus reflected at said first equipment; and (d) comparing said signal thus reflected with said transmitted signal to thereby extract said first bit sequence. By using the signal reflection, a reduction in circuitry, complexity and energy consumption is possible relative to existing communication standards. In a preferred electronic embodiment, reflection of the signal in a manner according to a first bit sequence is achieved by modulating the impedance at the end of a transmission line connecting the equipment.

If circumstances require that a particular slave node be allocated more network bandwidth allocation, the decision and execution can all be undertaken within the master node. The other network nodes do not require a change of configuration. Such a situation may be envisaged, for example, in automotive applications where the network may carry data both for the in-car entertainment system and for the ABS braking system. When the brakes are applied, increased network bandwidth can be allocated by the controller to the brake slave node without the need to re-set all the slave nodes as would be required in a time-triggered architecture.

Compared to a direct, hard-wired communications system, the arrangement of the invention also requires less wiring (and is consequently less expensive) as a result of each servo only requiring an individual transmission line as far as the router, which then prevents access to the transmission line to the controller unless instructed by the controller.

In some applications, e.g. large aircraft, where there is a large distance between the controller and a group of servos, the router can be placed near the group of servos. As a result, the length of the transmission line between the controller and the router is greater than the length of the transmission line between the router and the slave nodes. This in turn results in significant savings in transmission line.

Where, as is advantageously the case, the router is configured to isolate —advantageously physically—each deselected downstream node, each servo or slave node cannot send a feedback control signal to the controller unless the router has been set accordingly by the controller. This avoids the ‘babbling idiot’ problem, thus eliminating the need for bus guardians.

Advantageously, the further signal for controlling the router shares a transmission line with said control signal. The aforementioned WO99/35780 also describes the construction and control of suitable router which behaves somewhat like a reflective signalling node in using the same signalling, but has no need to send or receive large amounts of data. Its main purpose is to allow any master quickly to address specific nodes in a large system and to isolate most of the nodes from signals from the master, thus minimise attenuation and spurious reflection effects. In its simplest form, a router may have three ports, allowing one transmission line to be split or for three lines to be joined (depending on perception). Such routing from one port to one other may involve leaving the other port always appearing open-circuit. However, multi-way routers are feasible.

This router can also present an ‘engaged’ condition by in-phase open-circuit reflection of any master signals arriving at the port that is switched out. However, it will switch by the first valid master bit signal it receives from any of the three ports, say binary ‘1’ value for the left hand port as clockwise and binary ‘0’ value for the right hand port or anti-clockwise.

Once switched, the router cannot be changed until a reset condition is detected at the port which instigated the switching. Such a reset condition advantageously forms the first part of the incoming signal. All the nodes up to any active node on the non-selected line of the router will get no signal which will be interpreted as the ‘reset’ condition and prime them for later selections. After a reset condition/period is detected from the port that set the path of the router, all the inputs are returned to characteristic (absorb, i.e. non reflect) termination resistance and the router is available for control by the first master signal to arrive on one of the three ports.

Other hardware or software logic features may include allowing the router to make its characteristic impedance termination persist for a particular port to furnish a convenient termination when using the above broadcast feature. Alternatively or in addition, the router may detect when a master sends a routing direction signal followed by a unique bit signal or “strobe”. Such a signal can cause the router to hold or restore the characteristic termination impedance for the input port and ignore any other route selection. In such circumstances, the other two ports could still be switched together by master signals on either one of those ports, the ‘engaged’ signal being returned only should an attempt be made to route onto the port with the held characteristic termination impedance. Such a port will return to normal operation on receipt of a reset signal, however.

In a reflective signalling system, only the master node can transmit onto the bus medium. The slave nodes respond by modulating the terminating impedance between open and short circuit which reflects a data stream back to the master node. By its very nature, a slave node cannot actually transmit; it can only control reflections. Therefore a reflective signalling slave node is by definition ‘fail silent’.

Furthermore, as the returning datastream from a slave node is a reflection at point of incidence with the slave node, the time delay is determined by the physical bus structure. Therefore a reflective signalling system offers the fastest response time possible for a given medium. Reflective signalling is also inherently composable as a result of all timing information being held within the master node and the response times being predictable.

Advantageously, the controller comprises means for analysing a reflected signal in order to detect transmission line faults. In particular, reflective signalling's inherent use and detection of signal reflections also allows fault detection and location by means of time domain reflectometry, as known per se from the aforementioned WO99/35780. Receiver circuitry at a master node can be supplemented with a high resolution timer plus a facility to adjust the receive threshold settings, typically DAC controlled. This forms the basis of a time domain reflectometry system where exact round-trip signal times and amplitudes can be monitored from a master. With programmable receive thresholds the master can lower the thresholds and detect low-level reflections from cables, connector damage etc. This facilitates exact location of a fault in a line since any deviation from nominal impedance (higher or lower impedance) caused by a short circuit or an open circuit results in a reflection. Also, when a coaxial cable is crushed or stretched badly it experiences a measurable change of characteristic impedance and therefore gives reflections. Such capability enables a fault tolerant system to be constructed.

### BRIEF DESCRIPTION OF DRAWINGS

The invention will now be described by way of example with reference to the following diagrams, of which:

FIG. 1 is a block diagram of a communications network for a servo system according to a first embodiment of the invention;

FIG. 2 is a block diagram of a communications network for a servo system according to a second embodiment of the invention.

### MODE(S) FOR CARRYING OUT THE INVENTION

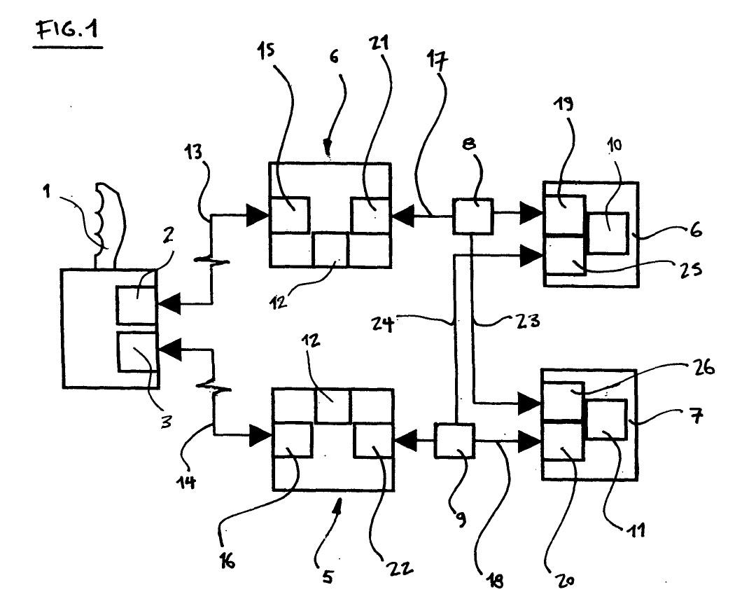

FIG. 1 shows an aerospace application in which a pilot input device 1 has two interfaces, namely slave nodes 2 and 3. These are each connected by respective transmission lines 13, 14 to two flight computers 4, 5 having respective master nodes 15, 16. Slave nodes 2 and 3 are respectively interrogated by master nodes 15 and 16, allowing computers 4 and 5 to make independent decisions about how to alter the flight surfaces 6,7. The timing of the two computers is coordinated by means of local timebase generators 12.

The commands to alter the flight surfaces are then transmitted from the flight computers by second master nodes 21, 22 via routers 8, 9 and transmission lines 17, 18 to the slave nodes 19, 20 of the respective flight surface CPUs 10, 11. Those same CPUs subsequently send feedback control signals to the controller by the same route. Redundancy can also be obtained by providing the flight surface CPUs 10,11 with further slave nodes 25,26 cross connected via transmission lines 23 and 24 and routers 8,9 to the other respective computer 5 or 6.

The present invention is particularly suited to applications of this nature for a number of reasons. Firstly, the owner of every network branch is unchanging, namely the master node, so that there can be no contention. Secondly, if a slave node fails, the nature of reflective signalling is such that it will not disrupt any network communications: it cannot become the ‘babbling idiot’. Thirdly, a failed slave node can be isolated by the nearest router. Fourthly, routers can be cascaded, so that should a router fail, it will only isolate those elements of the network downstream of the router.

Furthermore, the present invention is well suited to servo control applications and servo control loops. A servo system consists of a mechanical actuator, a sensing device to measure the location of the actuator, and a control system to ensure that the actuator moves in a controlled manner. If there is a random or variable time delay between the control system and the actuator or sensing device, then the control loop will not operate optimally, and may even become unstable and oscillate. A conventional servo system will therefore contain all the above elements within a close proximity to each other so the time delay between the various elements is minimised.

A distributed servo system is not possible with the event-triggered architecture as there is a random time delay between the control system and the actuator and sensor. Although time-triggered architecture can be used for a servo control application, the control loop response times will be limited to the next timeslot in the global timeframe. In contrast, the network architecture of the present invention is eminently suitable for use in such a distributed servo control application because the response time between the control system, i.e. the master node, and the sensor and actuator, i.e. the slave node, is simply the length of cable between the two. There is no processing delay or non-determinable communication latency. Note that by locating the router further away from the master node than the slave nodes (as indicated by the zig-zag in the transmission lines 13 and 14 of FIG. 1), wiring is minimized in the manner already discussed above.

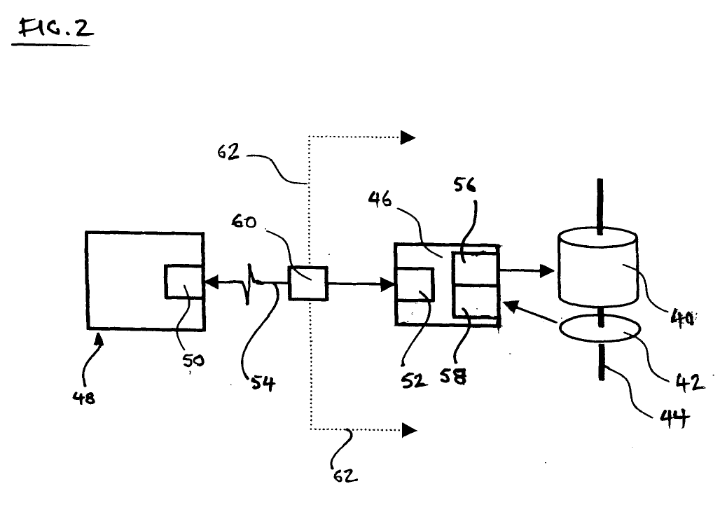

FIG. 2 shows the application of the invention to a motor servo system. A motor 40 and encoder 42 are mounted on a common shaft 44 enabling the encoder to monitor the actual motor position. Via electronics 46, the motor is controlled remotely by the control system CPU 48 and the resultant shaft position is monitored remotely by the same control system CPU. This allows the CPU to accurately and rapidly position the shaft precisely, using feedback to compensate for any load on the shaft that may be present.

Specifically, the master node 50 within the system controller 48 has complete ownership and control of the network. The slave node 52 within the remote electronics 46 receives commands from the master 50 via transmission line 54 and responds quasi—instantaneously by means of reflective signalling. Such instant response coupled with the deterministic cable delay enables the architecture of the present invention to be used for a control system. In additional, slave node 52 will receive commands to control the motor driver 56 which operates the motor 40. The resultant position of the shaft 44 is read by the shaft encoder 42 which is monitored by the position sensor electronics 58 and fed to slave node 52 where it can be read by the master 50 to enable the effect of the motor control command to be established.

A router 60 allows the system controller 48 to communicate with additional servos as indicated by dashed lines 62. As discussed above, the router is preferably located nearer the slave nodes than the master node in order to minimize wiring.

1. A communications network for servo systems and the like comprising:
a controller;
first and second slave nodes configured to respond to control signals from the controller and to send respective feedback control signals to the controller; and
a control signal transmission line between the controller and the slave nodes;
wherein communication between said controller and said slave nodes employs reflective signalling, and
wherein the transmission line incorporates a router configured to route control signals from said controller to one or other of said first and second slave nodes in dependence on a further signal from said controller.

2. Communications network according to claim 1, wherein the length of the transmission line between the controller and the router is greater than the length of the transmission line between the router and one of the slave nodes.

3. Communications network according to claim 1 or 2, wherein said further signal shares a transmission line with said control signal.

4. Communications network according to claim 1 or claim 2, wherein said router is configured to isolate each deselected downstream node.

5. Communications network according to claim 1 or claim 2, wherein said controller comprises a reflected signal analyser adapted to detect transmission line faults.
